(19) United States
(12) Patent Application Publication
(10) Pub. No.: US 2004/0185150 A1
(43) Pub. Date: Sep. 23, 2004

(54) Dissolvable flavoring capsules

(76) Inventors: Constance Pauline Francis, Richmond, UT (US); Cristi Dianne Cottle, Richmond, UT (US)

Correspondence Address: KUNZLER & ASSOCIATES, 8 EAST BROADWAY, SALT LAKE CITY, UT, 84111, US

(21) Appl. No.: 10/802,997

(22) Filed: Mar. 17, 2004

Related U.S. Application Data
(60) Provisional application No. 60/456,258, filed on Mar. 20, 2003.

(51) Int. Cl. A21D 13/00

(52) U.S. Cl. 426/138

(57) ABSTRACT

A device, system, and method are provided for flavoring a food product. A dissolvable flavoring capsule comprises a capsule and a dissolvable flavoring mixture disposed within the capsule. The dissolvable flavoring mixture may include a filler and a flavoring additive. In operation, the dissolvable flavoring capsule may be placed in a food product and allowed to dissolve. The flavoring mixture permeates the food product, adding flavor to the food product. The dissolvable flavoring capsule may include an assortment of flavors. Consequently, a plurality of dissolvable flavoring capsules of different flavors may be combined to create a desired flavoring. In addition, the dissolvable flavoring capsule may be colored to correspond to the flavor of the dissolvable flavoring mixture.

### RELATED APPLICATIONS

This application is a continuation-in-part of and claims priority to U.S. Provisional Patent Application No. 60/456,258, filed on Mar. 20, 2003 and entitled “DISSOLVABLE FLAVORING CAPSULES.”

### BACKGROUND OF THE INVENTION

1. Field of the Invention

The invention relates to food flavoring. Specifically, the invention relates to food flavoring that is dissolvable in a food product.

2. Description of the Related Art

Generally, food products are sold pre-flavored, such as oatmeal, hot chocolate, milk, juice, yogurt, and the like. Consequently, the selection of flavoring for a specific food product typically must be made at the grocery store or at the time of purchase. The variety of flavors available may also be limited. Because the food products are pre-flavored, the available flavors are usually very basic. Plus, the user might purchase a new flavor to try it out and then discover later that the flavor is not desirable. As a result, large quantities of pre-flavored food products may be wasted.

Another common method to flavor food products is to add sugar or an artificial sweetener. This method typically is messy because granules are usually spilled while transferring the sweetener to the food products. Or, if small paper packets are used to package the sweetener, the user must dispose of the paper left over. Usually, a portion of the sugar or sweetener remains in the paper packet and ends up spilling onto the table or floor. The paper waste causes an additional waste that must be cleaned up. Similar problems exist with hot chocolate mixes, fruit drink mixes, creamers, and the like.

Also, with other food flavoring products it is often difficult to judge how much of the flavoring is needed to flavor a food product. Often, measuring devices are required to measure out a specified amount of powdered or liquid flavoring. During the measuring process, flavoring is often spilled, causing an additional mess.

Accordingly, what is needed is a device, system, and method for flavoring a food product that is simple and eliminates waste. The device, system, and method should offer the user a variety of flavors from which to choose to flavor various food products. In addition, the device, system, and method should provide a flavoring product that is pre-measured so that the user is not required to measure the flavoring product. Further the device, system, and method should be easy to store and transport, without leaving paper waste after use.

### BRIEF SUMMARY OF THE INVENTION

The present invention has been developed in response to the present state of the art, and in particular, in response to the problems and needs in the art that have not yet been met for flavoring a food product. Accordingly, the present invention has been developed to provide a device, system, and method for flavoring a food product with a dissolvable flavoring capsule that overcomes many or all of the above-discussed shortcomings in the art.

A device according to the present invention includes a dissolvable flavoring capsule that comprises a capsule and a selected amount of a dissolvable flavoring mixture disposed within the capsule. Preferably, the capsule is edible and dissolves quickly when in direct contact with moisture. In one embodiment, the capsule may be a gelatin capsule known in the art. The gelatin capsule may be flavored to enhance the effectiveness of the device. In a preferred embodiment, the flavor of the capsule corresponds to the flavor of the dissolvable flavoring mixture. In addition, the color of the capsule may also correspond to the flavor of the dissolvable flavoring mixture disposed within the capsule.

The dissolvable flavoring mixture preferably comprises a filler and a flavoring additive. In one embodiment, the filler may comprise nondairy creamer, and the flavoring additive may comprise flavoring oil. In select embodiments, the flavoring oil may be colored to identify the flavor of the dissolvable flavoring mixture. In an alternative embodiment, the dissolvable flavoring mixture further comprises a sweetener. Alternatively, the flavoring additive or filler may be a sweetener.

A method for flavoring a food product according to one embodiment of the present invention provides a dissolvable flavoring capsule, which comprises a capsule and a select amount of dissolvable flavoring mixture disposed within the capsule. Preferably, a variety of flavors of dissolvable flavoring capsules are available so that a desired flavor can be selected. Next, the dissolvable flavoring capsule is placed in a food product. Then, the dissolvable flavoring capsule is allowed to dissolve. Once the flavoring capsule dissolves, the dissolvable flavoring mixture is preferably dispersed throughout the food product, thereby flavoring the food product.

A system of the present invention comprises a capsule, a selected amount of dissolvable flavoring mixture disposed within the capsule, and a compact container for storing and transporting the dissolvable flavoring capsule. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of a dissolvable flavoring capsule according to one embodiment of the present invention;

FIG. 2 is a perspective view of a dissolvable flavoring capsule illustrating the dissolvable flavoring mixture disposed within the capsule according to one embodiment of the present invention;

FIG. 3 is a perspective view of one embodiment of a compact container suitable for storing and transporting the dissolvable flavoring capsule according to one embodiment of the present invention; and

FIG. 4 is a flow chart diagram illustrating a method for flavoring a food product with a dissolvable flavoring capsule according to one embodiment of the present invention.

### DETAILED DESCRIPTION OF THE INVENTION

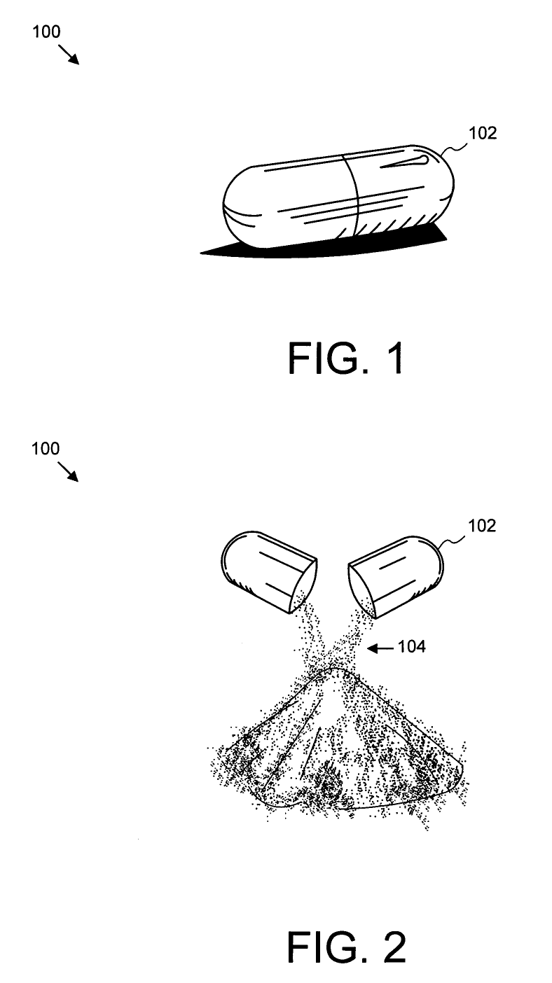

It will be readily understood that the components of the present invention, as generally described and illustrated in the figures herein, may be arranged and designed in a wide variety of different configurations. Thus, the following more detailed description of the embodiments of the device, system, and method of the present invention, as presented in FIGS. 1 through 4, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

FIGS. 1 and 2 illustrate one embodiment of a dissolvable flavoring capsule 100 for flavoring a food product. A capsule 102 preferably encases a selected amount of a dissolvable flavoring mixture 104. The dissolvable flavoring capsule 100 may be dissolved in a variety of food products to increase the flavor and variety of such food products.

Accordingly, the capsule 102 is preferably dissolvable and edible. The capsule 102 also provides form to the flavoring capsule 100 and functions as a container for the dissolvable flavoring mixture 104. The capsule 102 preferably dissolves quickly in liquids and other food substances, allowing a pre-measured amount of the flavoring mixture 104 to be released into the food product. In one embodiment, the capsule 102 comprises a gelatin capsule made from water and glycerite in a manner that is well known in the art. Gelatin capsules may be purchased from manufacturers such as NOW® Foods, located in Bloomingdale, Ill.

The capsule 102 may be comprised of a variety of materials to enhance the ability of the capsule 100 to dissolve quickly, or to better contain the flavoring mixture 104. In certain instances, the thickness of the walls of the capsule 100 may be selected to enhance dissolvability or to provide greater structure. Likewise, the capsule 102 may have various forms. In one embodiment, a capsule 102 may be shaped similar to a dissolvable tea bag and may contain a significant amount of flavoring mixture 104. Alternatively, the flavoring mixture 104 may be compressed into a hardened shell to form a capsule 102 around a small amount of flavoring mixture 104.

Because the capsule 102 is dissolvable, the dissolvable flavoring capsule 1100 may be added directly to a food product without removing any additional packaging, such as a paper packet or plastic wrap, which is often a cause of unnecessary waste. Also, a selected amount of flavoring mixture 104 is disposed within the capsule 102, so a user is not required to measure the flavoring mixture 104 before adding the mixture 104 to a food product. Furthermore, because the mixture 104 is contained within the capsule 102, the mixture 104 typically does not spill or soil a surrounding area. Thus, the dissolvable flavoring capsule 100 does not produce unwanted bulk or mess.

The capsule 102 in yet another embodiment may be flavored. In certain embodiments, the flavor of the capsule 102 corresponds to the flavor of the flavoring mixture 104. The color of the capsule 102 may also correspond to the flavor of the flavoring mixture 104. The color of the capsule 102, as well as the color of the flavoring mixture 104, may be useful to identify the flavor of the dissolvable flavoring capsule 100. For example, a red flavoring capsule 100 may indicate a cherry flavoring, and a blue flavoring capsule 100 may identify a blueberry flavoring. Preferably, the dissolvable flavoring capsule 100 may be selected from a large assortment of flavors and colors, including exotic flavors and colors. In certain embodiments, various dissolvable flavoring capsules 100 may be used to flavor a food product. As a result, multiple flavors may be combined to create a unique flavoring.

The dissolvable flavoring mixture 104 may also include a variety of components. In certain embodiments, the flavoring mixture 104 may be a flavoring mixture available in the market. Additionally, the flavoring mixture 104 may be colored to indicate a specific flavor or flavoring.

In one embodiment, the flavoring mixture 104 comprises a filler and a flavoring additive. The filler may be a nondairy creamer generally available in grocery stores. A list of ingredients in the nondairy creamer may include: corn syrup solids, partially hydrogenated soybean oil, sodium caseinate (a milk derivative), dipotassium phosphate, mono- and diglycerides, silicon dioxide, sodium stearoyl lactylate, and soy lecithin. Alternatively, the filler in the flavoring mixture 104 may be oil, water, sugar, powdered milk, or any other suitable filler.

The flavoring additive may be any material or composition that is capable of flavoring another material. In a select embodiment, the flavoring additive comprises flavoring oil. Flavoring oils are typically soybean oil based and are made with natural and artificial flavors. Flavoring oils are commonly used to flavor suckers and candy. Artificial coloring may also be added to the oil to indicate the flavor of the oil.

In an alternative embodiment, the flavoring additive may be a sweetener, such as sugar or artificial sweeteners. Alternatively, a sweetener may be added to the dissolvable flavoring mixture 104 in addition to the filler and flavoring additive.

In a preferred embodiment, a ratio of components for the flavoring mixture 104 is one to three ounces of flavoring oil to every 35.3 ounces (approximately eight cups) of nondairy creamer. The process to create the flavoring mixture may comprise measuring the nondairy creamer and the flavoring oil according to the preferred ratio, combining the two ingredients in a bowl, and then mixing the creamer and the flavoring oil with a wire whisk, food processor, or the like. This process creates a flavored powder mixture that can be fashioned into capsule form. In one embodiment, the flavoring mixture is inserted into gelatin capsules by using a plastic device designed specifically to fill and cap gelatin capsules. One example is a device called cap.m.quick available from S. L. Sanderson Co., Berry Creek, Calif.

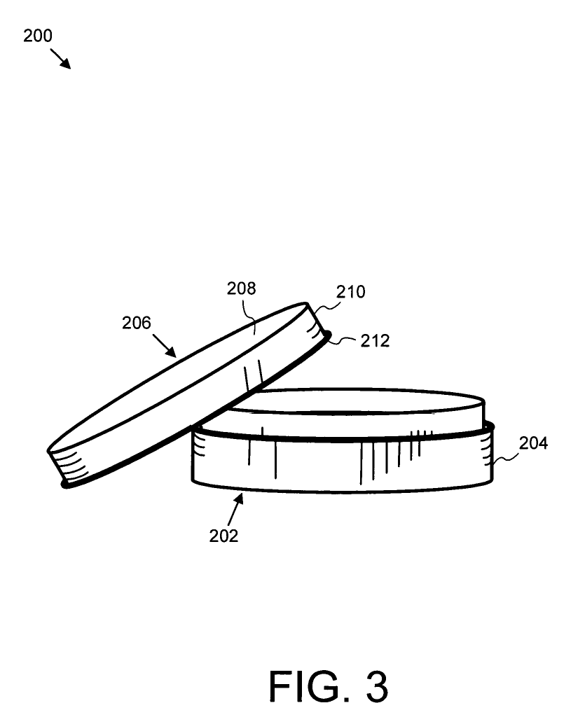

FIG. 3 illustrates one embodiment of a compact container 200 that may be used to store and transport the dissolvable flavoring capsule 100. The container 200 may be similar to a small metal tin. The shape of the bottom 202 of the container 200 may be round to eliminate all sharp corners. The sides 204 of the container 200 may circumscribe the circular bottom 202. Furthermore, the sides 204 may be short in height, so the container 200 may be relatively flat.

The cover 206 of the container 200 may be similar to the container 200 in that the cover 206 may have a circular base 208 with sides 210 extending from the base 208. However, the cover 206 is preferably larger than the container 200 so as to fit tightly over the container 200. A rolled edge 212 around the cover 206 may serve as a leverage to help the user remove the cover 206 from the container 200. In certain embodiments, the cover 206 may include a label identifying the flavor of the flavoring capsule 100 stored within the container 200.

The container 200 preferably fits in a pocket, purse, glove compartment, drawer, or any place that is suitable for use or storage of the product. In certain embodiments, the container 200 may include sections inside the container 200 to separate the different flavors of dissolvable flavoring capsules 100. Of course, any suitable container 200 may be used to store or transport the dissolvable flavoring capsule 100. However, the dissolvable flavoring capsule 100 is preferably packaged to offer convenience and to eliminate waste.

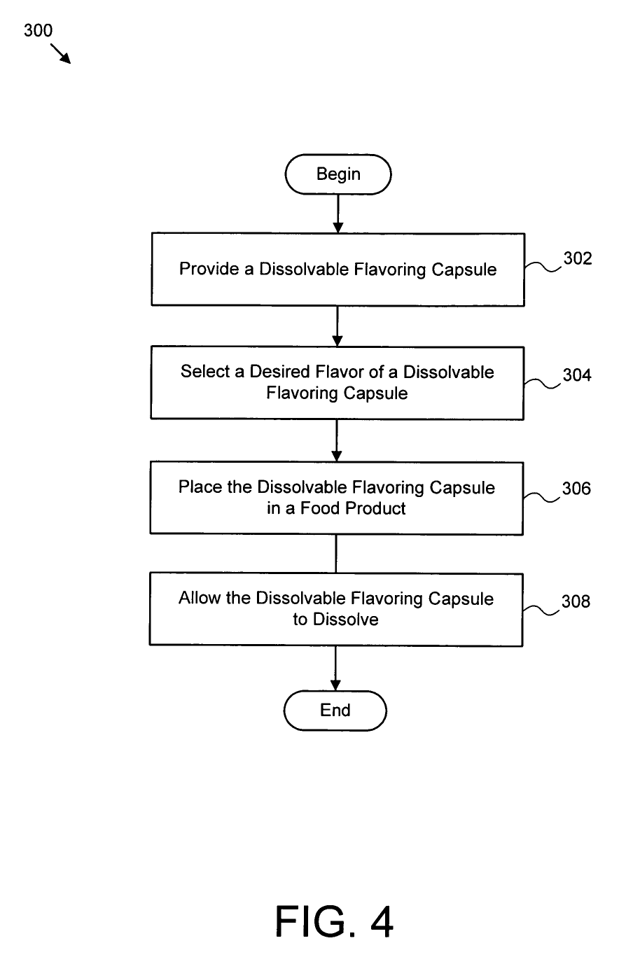

FIG. 4 illustrates a method 300 for flavoring a food product according to one embodiment of the present invention. The method 300 begins by providing 302 a dissolvable flavoring capsule 100. As mentioned, the flavoring capsules 100 are preferably flavored many different flavors and may be colored accordingly.

Consequently, a user may select 304 a flavor to add to a food product. Also, a user may select one or more flavors or flavoring capsules 100 to add to a food product. As a result, the available flavors may be combined to strengthen a chosen flavor or to create additional flavors. Of course, the strength of the flavoring may depend on the size of the flavoring capsule 100 and the amount and kind of flavoring mixture 104 disposed within the capsule 102.

Once selected, the dissolvable flavoring capsule(s) 100 may then be placed 306 in a food product. The flavoring capsule(s) 100 are then allowed to dissolve 308. Preferably, the capsule 102 dissolves such that the flavoring mixture 104 is released into the food product. The flavoring mixture 104 then dissolves or mixes with the food product, thereby adding flavor to the food product. The food may be stirred or mixed to evenly distribute the flavoring if desired. Then the method 300 ends.

The flavoring capsules 100 may be dissolved in a variety of food products, such as coffee, hot chocolate, tea, water, milk, juice, oatmeal, cream of wheat, yogurt, pudding, or the like. The user can choose from an assortment of flavors and can experiment flavoring many kinds of food products. The dissolvable flavoring capsules 100 allow the user to create an assortment of food products simply by adding flavoring. In addition, the flavoring capsules 100 are pre-measured and are easy to store and transport, without leaving paper waste after use.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dissolvable flavoring capsule, comprising:
a capsule;
a selected amount of a dissolvable flavoring mixture disposed within the capsule, the dissolvable flavoring mixture comprising a filler and a flavoring additive.

2. The dissolvable flavoring capsule of claim 1, wherein the capsule comprises a gelatin capsule.

3. The dissolvable flavoring capsule of claim 1, wherein the capsule is flavored.

4. The dissolvable flavoring capsule of claim 1, wherein the flavor of the capsule corresponds to the flavor of the dissolvable flavoring mixture.

5. The dissolvable flavoring capsule of claim 1, wherein the color of the capsule corresponds to the flavor of the dissolvable flavoring mixture.

6. The dissolvable flavoring capsule of claim 1, wherein the filler comprises nondairy creamer.

7. The dissolvable flavoring capsule of claim 1, wherein the flavoring additive comprises flavoring oil.

8. The dissolvable flavoring capsule of claim 7, wherein the flavoring oil is colored to identify the flavor of the dissolvable flavoring mixture.

9. The dissolvable flavoring capsule of claim 1, wherein the flavoring additive comprises a sweetener.

10. The dissolvable flavoring capsule of claim 1, wherein the dissolvable flavoring mixture further comprises a sweetener.

11. The dissolvable flavoring capsule of claim 1, wherein the dissolvable flavoring mixture comprises a flavoring oil and nondairy creamer in a ratio of one to three ounces of flavoring oil to every 35.3 ounces of nondairy creamer.

12. A method for flavoring a food product, the method comprising:
providing a dissolvable flavoring capsule comprising a capsule and a selected amount of dissolvable flavoring mixture disposed within the capsule, the dissolvable flavoring mixture comprising a filler and a flavoring additive;
selecting a desired flavor of a dissolvable flavoring capsule;
placing the dissolvable flavoring capsule in a food product; and
allowing the dissolvable flavoring capsule to dissolve.

13. The method of claim 12, wherein the capsule comprises a gelatin capsule.

14. The method of claim 12, wherein the filler comprises nondairy creamer.

15. The method of claim 12, wherein the flavoring additive comprises flavoring oil.

16. The method of claim 12, wherein the dissolvable flavoring mixture further comprises a sweetener.

17. A system for flavoring a food product comprising:
a capsule;
a selected amount of dissolvable flavoring mixture disposed within the capsule, the dissolvable flavoring mixture comprising a filler and a flavoring additive; and
a compact container for storing and transporting a plurality of dissolvable flavoring capsules.

18. The system of claim 17, wherein the capsule comprises a gelatin capsule.

19. The system of claim 17, wherein the filler comprises nondairy creamer.

20. The system of claim 17, wherein the flavoring additive comprises flavoring oil.
